(19) United States
(12) Patent Application Publication
(10) Pub. No.: US 2008/0163679 A1
(43) Pub. Date: Jul. 10, 2008

(54) Method for Operating an Internal Combustion Engine, Internal Combustion Engine, and Control Unit for an Internal Combustion Engine

(76) Inventor: Heinz Viel, Korntal-Muenchingen (DE)

Correspondence Address: KENYON & KENYON LLP, ONE BROADWAY, NEW YORK, NY, 10004, US

(21) Appl. No.: 11/628,604

(22) PCT Filed: May 31, 2005
(86) PCT No.: PCT/EP05/52480

§ 371 Date: Sep. 26, 2007

(30) Foreign Application Priority Data
Jun. 4, 2004 (DE) 10 2004 027 535.7

(51) Int. Cl. G01M 15/02

(52) U.S. Cl. 73/114.34

(57) ABSTRACT

A method for operating an internal combustion engine, in which an engine temperature and an intake air temperature are ascertained. In the operating method described, a plausibility check of the engine temperature is performed using the intake air temperature and/or a plausibility check of the intake air temperature is performed using the engine temperature. Furthermore, a control unit for an internal combustion engine as well as a computer program for a control unit of an internal combustion engine and an internal combustion engine are described.

### FIELD OF THE INVENTION

The present invention relates to a method for operating an internal combustion engine, in which an engine temperature and an intake air temperature are ascertained.

### BACKGROUND INFORMATION

Furthermore, the present invention relates to an internal combustion engine and a control unit for an internal combustion engine, as well as a computer program for a control unit of an internal combustion engine.

Ascertaining the engine temperature is used for monitoring proper operation of the internal combustion engine, those engine temperatures preferably being maintained at which the lowest possible pollutant emissions occur. Operation outside these preferred engine temperatures may, inter alia, result in legally required limiting values for the pollutant emissions of the internal combustion engine being exceeded.

Known operating methods do typically offer the possibility of function monitoring of temperature sensors, but recognition of whether a signal of a temperature sensor is subjected to an erroneous positive offset value, for example, is not possible using current operating methods without using additional temperature sensors. Such an erroneous offset value of the signal may be caused by a parasitic parallel resistance in a signal line of the affected temperature sensor, for example.

In addition, in the typical operating methods, erroneous “stuck” signals in a specific temperature range may not be recognized in an overall temperature range of the internal combustion engine, so that approximately the same, incorrect temperature is always ascertained independently of an actual engine temperature.

### SUMMARY OF THE INVENTION

Accordingly, it is the object of the present invention to specify an operating method for an internal combustion engine, an internal combustion engine, and a control unit for an internal combustion engine in which more reliable recognition of errors affecting temperature sensors is possible.

This object is achieved according to the present invention in an operating method of the type cited at the beginning in that a plausibility check of the engine temperature is performed using the intake air temperature and/or a plausibility check of the intake air temperature is performed using the engine temperature.

For this purpose, the fact is advantageously exploited that in an internal combustion engine, two separate temperature sensors are typically provided, one of these temperature sensors being used for ascertaining the engine temperature and the second temperature sensor being provided for ascertaining the intake air temperature.

According to the present invention, the particular ascertained temperature values are subjected to a plausibility check, the effect also very advantageously being exploited that under specific operating conditions of the internal combustion engine, an equalization of the intake air temperature to the engine temperature or, vice versa, an equalization of the engine temperature to the intake air temperature occurs.

The operating method according to the present invention has the advantage that no additional sensors or other components have to be attached to the internal combustion engine, because of which it is possible to equip internal combustion engines already in the field by changing control unit software, for example. A change of the particular control unit hardware, in contrast, is also not necessary.

In particular the above-mentioned errors of an offset value or a “stuck” signal, which are not recognizable according to the related art, may be recognized by the operating method according to the present invention.

According to an advantageous embodiment of the present invention, the engine temperature is compared to the intake air temperature. A malfunction of at least one of the two temperature sensors may be concluded on the basis of too large a deviation between the intake air temperature and the engine temperature.

A comparison between the engine temperature and the intake air temperature is particularly advantageously performed in a predefinable time interval, preferably after the internal combustion engine has been shut down. It is thus ensured that the plausibility check according to the present invention is first executed when a plausibility check is in fact practically possible. This is not the case during operation of the internal combustion engine, for example, while fresh air is always flowing into an intake system of the internal combustion engine, because this fresh air typically has a significantly lower temperature than the internal combustion engine itself. Only after the internal combustion engine has been shut down does fresh air not flow continuously into the intake system, and there may be a temperature comparison between the internal combustion engine and the intake air, i.e., after the internal combustion engine has been shut down, the intake air temperature and the engine temperature approach one another.

In a further embodiment of the operating method according to the present invention, the comparison between the engine temperature and the intake air temperature is particularly advantageously performed after a temperature equalization between the engine temperature and the intake air temperature.

The implementation of the method according to the present invention in the form of a computer program which is provided for a control unit of an internal combustion engine, in particular of a motor vehicle, is of special significance. The computer program is capable of both being run on a microprocessor in particular and of performing the method according to the present invention. In this case, the present invention is thus implemented by the computer program, so that this computer program represents the present invention in the same way as the method which the computer program is capable of performing. The computer program may be stored on an electrical memory medium, such as a flash memory or a read-only memory.

A control unit and an internal combustion engine are specified as further ways of achieving the object of the present invention.

### BRIEF DESCRIPTION OF THE DRAWINGS

FIG. 1 shows a schematic block diagram of an exemplary embodiment of an internal combustion engine according to the present invention.

FIG. 2 shows a logic circuit for performing the method according to the present invention.

FIG. 3 shows a further logic circuit.

FIG. 4 shows a cooling curve of an internal combustion engine.

### DETAILED DESCRIPTION

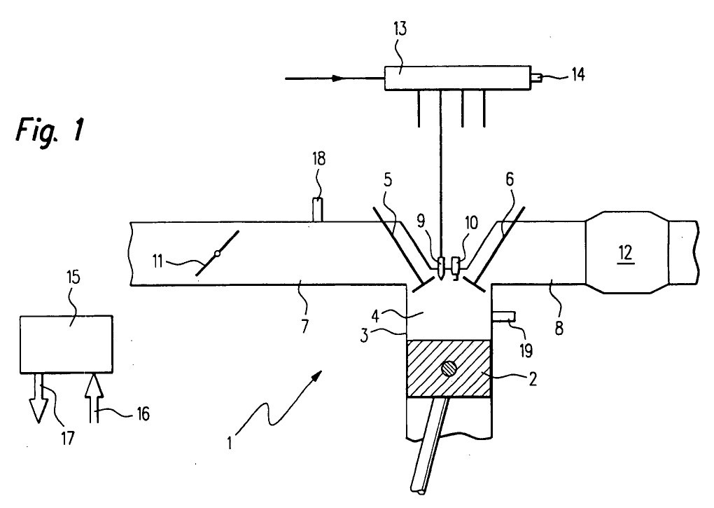

FIG. 1 shows an internal combustion engine 1 of a motor vehicle, in which a piston 2 is movable back and forth in a cylinder 3. Cylinder 3 is provided with a combustion chamber 4, which is delimited, inter alia, by piston 2, an inlet valve 5, and an outlet valve 6. An intake manifold 7 is connected to inlet valve 5 and an exhaust pipe 8 is connected to outlet valve 6.

A fuel injector 9 and a spark plug 10 project into combustion chamber 4 in the area of inlet valve 5 and outlet valve 6. Fuel may be injected into combustion chamber 4 via fuel injector 9. The fuel in combustion chamber 4 may be ignited using spark plug 10.

A rotatable throttle valve 11 is housed in intake manifold 7, via which air may be supplied to intake manifold 7. The quantity of air supplied is a function of the angle of throttle valve 11. A catalytic converter 12 is housed in exhaust pipe 8, which is used for purifying the exhaust gases resulting due to the combustion of the fuel.

Fuel injector 9 is connected via a pressure line to a fuel accumulator 13. In a corresponding way, the fuel injectors of the other cylinders of internal combustion engine 1 are also connected to fuel accumulator 13. Fuel accumulator 13 is supplied with fuel via a supply line. An electrical and/or mechanical fuel pump, which is capable of building up the desired pressure in fuel accumulator 13, is provided for this purpose.

Furthermore, a pressure sensor 14 is situated on fuel accumulator 13, using which the pressure in fuel accumulator 13 is measurable. This pressure is the pressure which is exerted on the fuel, and therefore at which the fuel is injected via fuel injector 9 into combustion chamber 3 of internal combustion engine 1.

In operation of internal combustion engine 1, fuel is conveyed into fuel accumulator 13. This fuel is injected via fuel injectors 9 of individual cylinders 3 into associated combustion chambers 4. With the aid of spark plugs 10, combustions are produced in combustion chambers 3, through which pistons 2 are set into a back-and-forth movement. These movements are transmitted to a crankshaft (not shown) and exert a torque thereon.

A control unit 15 has input signals 16 applied to it, which represent operating variables of internal combustion engine 1 measured using sensors. For example, control unit 15 is connected to pressure sensor 14, an air mass sensor, a lambda sensor, a speed sensor, and the like. Furthermore, control unit 15 is connected to a temperature sensor 18, which allows detection of the intake air temperature in intake manifold 7, and to a temperature sensor 19 for detecting the engine temperature or the temperature of a coolant of the internal combustion engine. Temperature sensor 18 may also be situated upstream from throttle valve 11, i.e., left thereof in FIG. 1.

Control unit 15 produces output signals 17, using which the behavior of internal combustion engine 1 may be influenced via actuators or final control elements. For example, control unit 15 is connected to fuel injector 9, spark plug 10, and throttle valve 11 and the like and produces the signals required for their activation.

Among other things, control unit 15 is provided for the purpose of controlling and/or regulating the operating variables of internal combustion engine 1. For example, the fuel mass injected by fuel injector 9 into combustion chamber 4 is controlled and/or regulated by control unit 15 in particular in regard to low fuel consumption and/or low pollutant development. For this purpose, control unit 15 is provided with a microprocessor, which has a computer program, which is capable of performing the cited control and/or regulation, stored in a memory medium, in particular a flash memory.

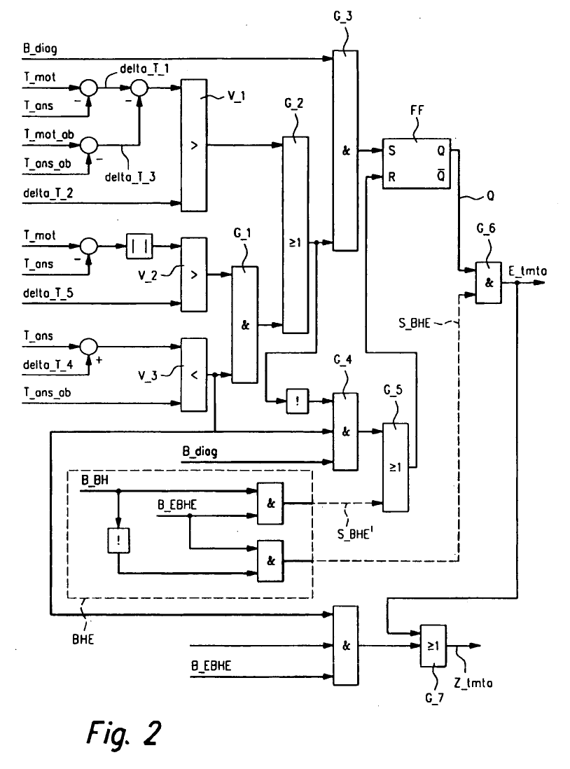

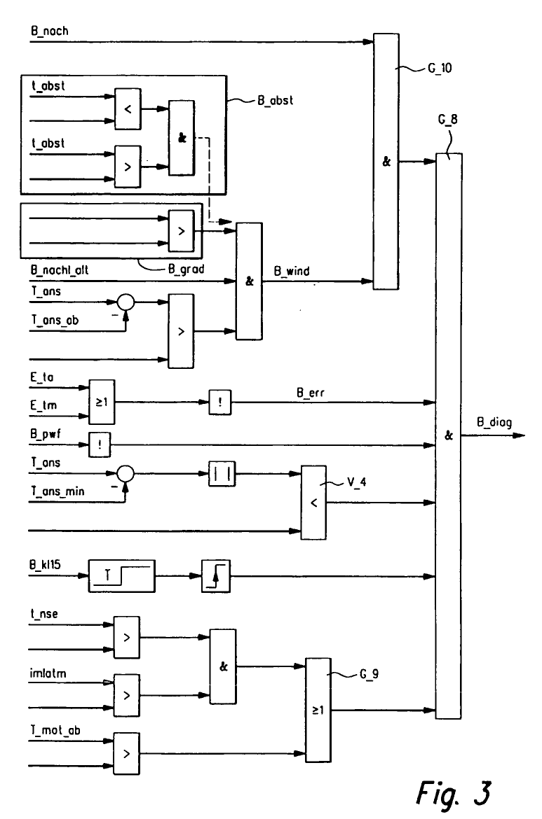

FIG. 2 shows a detail of a logic circuit, as is implemented in control unit 15. The detail shown describes the essential steps of the operating method according to the present invention for the mutual plausibility check of an engine temperature T_mot detected using temperature sensor 19 and an intake air temperature T_ans detected using temperature sensor 18. For this purpose, the output signals of the logic switching elements shown in FIG. 2 and FIG. 3 may only assume the two values zero (false) and one (true).

If the plausibility check provides a negative result, i.e., if a plausibility check error is recognized, this is indicated by an error signal E_tmta applied to the output of gate G_6; i.e., the output of gate G_6 assumes the value one. Otherwise, i.e., without a plausibility check error, the output of gate G_6 has the value zero.

As shown in FIG. 2, the output value of gate G_6, which is implemented as an AND element, is determined by signals Q and S_BHE.

Signal Q is produced in RS flip-flop FF based on input signals S, R according to the following function table, the number “1” meaning logical one and the number “0” meaning logical zero:

| R | S | Q |
|---|---|---|
| 0 | 1 | 1 |
| 1 | 0 | 0 |

Signal Q has a value of one when signal R applied to the input also identified as the reset input of flip-flop FF is zero and when signal S applied to the input also identified as the set input of flip-flop FF is one. With signals R, S complementary thereto, signal Q is equal to zero. In the following, both the reset and set inputs of flip-flop FF and also corresponding signals R, S applied to these inputs are identified by the reference notation R, S.

In the following, gate G_3, which is implemented as an AND element, whose output is connected to the set input of flip-flop FF and thus provides signal S, is described first.

Gate G_3 has two input signals, first input signal B_diag indicating whether the operating conditions for the plausibility check according to the present invention are provided at all. Signal B_diag is only one when the plausibility check according to the present invention of engine temperature T_mot and intake air temperature Trans may be performed expediently. The conditions for this purpose are described below with reference to FIG. 3.

The second input signal of gate G_3 is simultaneously the output signal of gate G_2, which is implemented as an OR element, which in turn receives input signals from comparator V_1 and gate G_1, which is implemented as an AND element.

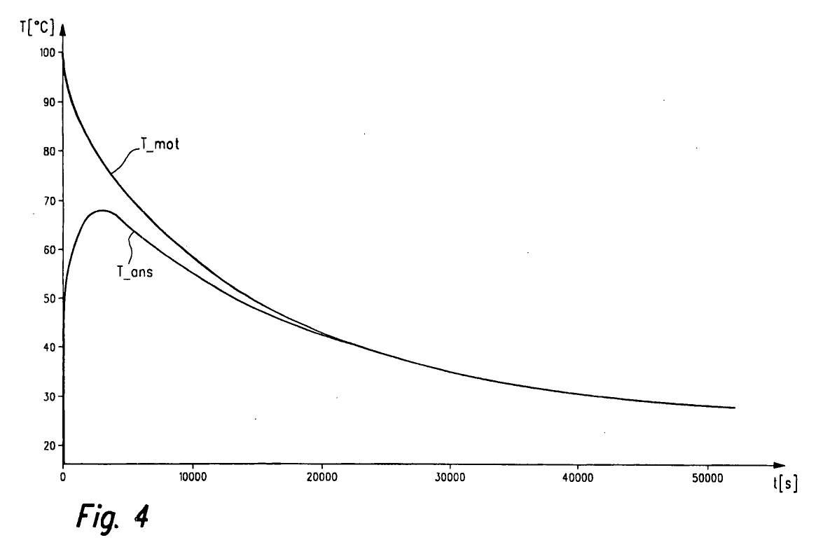

Comparator V_1 performs a check as to whether a temperature difference delta_T_1 between instantaneous engine temperature T_mot and instantaneous intake air temperature T_ans deviates by more than a threshold value delta_T_2, which is also supplied to comparator V_1, from a temperature difference delta_T_3 between engine temperature T_mot_ab and intake air temperature T_ans_ab at the instant of when internal combustion engine 1 is shut down (FIG. 1). Since a temperature difference between engine temperature T_mot and intake air temperature T_ans is progressively reduced according to the cooling curve shown in FIG. 4 of internal combustion engine 1 after the shutdown of internal combustion engine 1 (corresponding to instant t=0 in FIG. 4) due to a heat exchange between internal combustion engine 1 and the air located in intake manifold 7, with functioning temperature sensors 18, 19, it is expected that temperature difference delta_T_1−delta_T_3 will not exceed a predefinable threshold delta_T_2.

As is apparent in FIG. 4, the temperature difference

delta_{—}T_{—}3=T_{—}mot_{—}ab−T_{—}ans_{—}ab

has a value of approximately 50° C., with, as already indicated

T_{—}mot_{—}ab=T_{—}mot(t=0) and

T_{—}ans_{—}ab=T_{—}ans(t=0)

as shown in FIG. 4.

After a cooling time of approximately 20,000 seconds, i.e., t=20000, for example, temperature difference delta_T_1 between instantaneous engine temperature T_mot and instantaneous intake air temperature T_ans has fallen to a few degrees Celsius.

Threshold delta_T_2 is a function of multiple parameters, such as placement of temperature sensors 18, 19 on and/or in internal combustion engine 1 and further components influencing the cooling behavior of internal combustion engine 1, so that it is expedient to make threshold delta_T_2 applicable and adapt it to the particular internal combustion engine.

In case of error, the temperature difference delta_T_1−delta_T_3 described above will exceed predefined threshold delta_T_2, so that a signal having a value one is applied to the output of comparator V_1, which is supplied to gate G_2 and, because of the implementation of gate G_2 as an OR element independently of an output signal of gate G_1, results in the output signal of gate G_2 also assuming a value of one.

With correct functioning of temperature sensors 18, 19, threshold delta_T_2 will not be exceeded because of the described cooling behavior of internal combustion engine 1, so that a signal having a value zero is applied to the output of comparator V_1.

Another possibility in which gate G_2 assumes an initial value of one is that the output signal of gate G_1 becomes one. Since gate G_1, as may be seen from FIG. 2, is implemented as an AND element, both of the following conditions must be fulfilled for this purpose:

Firstly, an absolute value of temperature difference delta_T_1′=T_mot−T_ans must be greater than a predefinable threshold value delta_T_5; and secondly, instantaneous intake air temperature T_ans must be smaller by more than a predefinable threshold value delta_T_4 than an intake air temperature T_ans_ab at the instant internal combustion engine 1 is shut down (t=0 in FIG. 4). The diagnosis thus occurs only when intake air temperature T_ans falls below intake air temperature T_ans_ab at the instant the internal combustion engine is shut down. A sufficiently long shutdown time for the equalization of engine and intake air temperatures is thus ensured.

If necessary, the smallest intake air temperature ascertained during the prior driving cycle may also be used as a comparison value for instantaneous intake air temperature T_ans.

Comparators V_2, V_3 accordingly check whether the particular threshold value has been exceeded or fallen below and relay the corresponding signal at their outputs to the inputs of gate G_1. The query of comparator V_3 predefines, as already discussed, the advisable instant for the comparison of the engine temperature and the intake air temperature.

If both input signals of gate G_1 have a value of one, i.e., if too large a temperature difference delta_T_1′ exists and if instantaneous intake air temperature T_ans is smaller by a preferably applicable threshold value delta_T_4 than intake air temperature T_1_ab upon shutdown of the internal combustion engine, gate G_1 outputs a value of one at its output. The second condition which may result in OR element G_2 outputting the value one at its output is thus defined.

Under the above-mentioned conditions, flip-flop FF may thus be set using signal S, so that with the simultaneous absence of a reset signal R, signal Q at the output of flip-flop FF may assume a value of one and thus allow the display of an error E_tmta. For this purpose, a function, which is also identified as block heater detector BHE and is shown using dashed lines in FIG. 2, is not previously taken into consideration.

In principle, the plausibility check according to the present invention is already possible solely using comparator V_1 or gate G_1 and their particular input variables. In this case, the particular output signal may already be used to indicate a plausibility check error.

Since the error conditions processed by comparator V_1 and gate G_1 may each occur individually or also simultaneously, they are advantageously combined by gate G_2 in an OR operation as shown in FIG. 2.

Together with the boundary conditions explained below for the plausibility check according to the present invention, indicated by signal B_diag, an even more reliable plausibility check is possible. Correspondingly, the output signal of gate G_3 may also be used as an indicator for a plausibility check error.

However, internal combustion engine 1 (FIG. 1) may be equipped with an auxiliary heater (not shown), also referred to as a block heater, which is used for preheating internal combustion engine 1 and improves a cold start of the internal combustion engine in very cold conditions, for example, in regard to reliability and pollutant emission during the start of the internal combustion engine. For this purpose, the block heater may be implemented, for example, as an electrical heating device which heats the cooling water of the internal combustion engine.

If a block heater of this type is present, a plausibility check according to the present invention may possibly no longer be performed reliably, inter alia, because heating of internal combustion engine 1 caused by the block heater interferes with the relationship between engine temperature T_mot and intake air temperature T_ans visible from the cooling curve in FIG. 4.

Therefore, signal S_BHE output by block heater detector BHE (FIG. 2) also acts on gate G_6, signal S_BHE being zero if a block heater or block heater operation has been detected and the plausibility check according to the present invention is thus not possible. In contrast, if no block heater or no block heater operation has been detected, signal S_BHE is one and output signal Q of flip-flop FF may act on error signal E_tmta as already described.

Furthermore, block heater detector BHE also has influence on flip-flop FF via gate G_5, which is described in greater detail in the following together with the general function of block heater detector BHE.

The block heater detector is based on two input signals B_BH, B_EBHE. Signal B_BH is one if a block heater has been detected, and signal B_EBHE is one if detection of the block heater has ended. It may be seen therefrom that output signal Q of flip-flop FF may only act on error signal E_tmta as described above if the procedure of block heater detection has been terminated, i.e., if B_EBHE is one and, simultaneously, no block heater has been detected, i.e., when signal B_BH is zero. Otherwise, i.e., if a block heater has been detected and/or if the block heater detection has not been terminated, signal S_BHE is zero.

If a block heater has been detected and the block heater detection has been terminated, signal S_BHE′ originating from block heater detector BHE acts on gate G_5, which is implemented as an OR element, so that reset input R of flip-flop FF is set to one. As a supplement to the above-mentioned function table of flip-flop FF, a signal having the value one at reset input R of flip-flop FF causes an output signal Q of zero independently of a signal applied to set input S. In this case, block heater detector BHE in turn prevents the setting of error signal E_tmta.

A further input signal of gate G_5 is produced by the output signal of gate G_4, which is implemented as an AND element, which assumes the value one under the following conditions as shown in FIG. 2: the output signal of gate G_2 must be zero, signal B_diag must be one, and thirdly instantaneous intake air temperature T_ans must be less by predefinable threshold value delta_T_4 than intake air temperature T_ans_ab at the instant internal combustion engine 1 is turned off. If these conditions are fulfilled, the output signal of gate G_5 and thus the signal applied to reset input R of flip-flop FF become one.

Instead of flip-flop FF, an AND element may also be used in principle. However, the block heater detection and the plausibility check represented by the output signal of gate G_3 may occur at different times, because of which temporary storage of the particular state using flip-flop FF is advantageous.

As a supplement, still a further gate G_7 is indicated in FIG. 2, which outputs a cycle flag Z_tmta, which indicates whether a plausibility check according to the present invention has occurred in the current cycle of internal combustion engine 1. The cycle flag is one when either error signal E_tmta has been set or when a signal output by comparator V_3 and signal B_EBHE and a signal which indicates whether signal B_diag has been set in the current operating cycle of internal combustion engine 1 simultaneously have the value one. Since the block heater detection may first be ended with a time delay after the plausibility check, variables B_diag and the output variables of comparator V_3 and gate G_7 must be temporarily stored.

In the following, it is described with reference to FIG. 3 under which conditions the plausibility check according to the present invention of engine temperature T_mot and intake air temperature T_ans may be performed and when signal B_diag is correspondingly set to one.

As shown in FIG. 3, signal B_diag is only set to one when all input signals of gate G_8 implemented as an AND element are one.

For this purpose, signal B_err must have a value of one, which is the case when an error has not already been established in connection with engine temperature T_mot and intake air temperature T_ans, i.e., when both error signals E_tm, E_ta are each zero. The plausibility check according to the present invention is not necessary if one or both error signals E_tm, E_ta are already one, i.e., a temperature signal error has already been detected in another way.

Furthermore, signal B_diag is only set to one if control unit 15 (FIG. 1) is not in or directly after a reset state, which occurs due to a temporary breakdown of a battery voltage or may also be caused in a targeted way by software, for example. This reset state of control unit 15 is indicated by signal B_pwf.

In addition, the absolute value of a temperature difference of instantaneous intake air temperature T_ans and a minimum intake air temperature T_ans_min from the preceding operating cycle of internal combustion engine 1 must be less than a threshold value not shown in greater detail in FIG. 3, which is checked by comparator V_4. The plausibility check according to the present invention is to be prevented in this way when significant changes in the ambient temperature occur during a shutdown time, i.e., after internal combustion engine 1 has been turned off.

Furthermore, B_diag is only set to one when the ignition of internal combustion engine 1 is turned on, which is indicated by signal B_k115, corresponding to a state of terminal 15 (cf. DIN 72 552). Signal B_k115 is particularly advantageously delayed by a waiting time. This waiting time allows the optimum instant for performing the plausibility check according to the present invention to be established specifically for every internal combustion engine in regard to the chronological detection of the temperature signals and the consistency of the temperature signals. For this purpose, the particular temperatures must absolutely be detected already, for example, but not yet changed by combustions occurring in the internal combustion engine.

In addition to the above-mentioned conditions, the signal output by gate G_9, implemented as an OR element, must also be zero so that signal B_diag is also set to one.

This is the case when engine temperature T_mot_ab at the instant of shutdown of internal combustion engine 1 does not exceed a threshold value (not shown in greater detail), i.e., when internal combustion engine 1 has reached its normal engine temperature in a preceding operating cycle. This normal engine temperature is approximately above 80° C. to 85° C., for example.

However, gate G_9 may output an output signal of one when a timer t_nse indicating the operating time of internal combustion engine 1 after its start exceeds a threshold (not shown) after a starting instant in the preceding operating cycle of internal combustion engine 1 and when an integrated air mass flow imlatm exceeds a threshold (not shown) after a starting instant in the preceding operating cycle of internal combustion engine 1.

Furthermore, for a signal B_diag of one, signals B_nach and B_wind, which are combined in gate G_10, implemented as an AND element, must have the value one, signal B_nach indicating that an afterrun of control unit 15 has ended, and signal B_wind indicating that no strong wind and/or an external fan have not been detected, which influence the cooling curve shown in FIG. 4 and may thus prevent a correct plausibility check.

The wind detection using signal B_wind is performed in the afterrun of control unit 15 of internal combustion engine 1, which is activated for a predefinable time after internal combustion engine 1 has been shut down. An overall rise of intake air temperature T_ans is monitored during the entire afterrun for the wind detection.

Furthermore, it is checked in block B_grad whether a gradient of intake air temperature T_ans exceeds a predefinable threshold value in a predefinable time slot after internal combustion engine 1 has been shut down. The threshold value is a function of intake air temperature T_ans_ab at the instant internal combustion engine 1 is shut down and is applicable.

The other threshold values described in reference to FIG. 2 and FIG. 3 are also advantageously applicable in order to achieve simple adaptation to different internal combustion engines or environmental conditions.

In still a further variation, a comparison of a temperature difference T_ans−T_ans_ab, from instantaneous intake air temperature T_ans and intake air temperature T_ans_ab at the instant internal combustion engine 1 is shut down, to a threshold value is performed, which is preferably a function of intake air temperature T_ans_ab at the instant internal combustion engine 1 is shut down.

Temperature sensor 18 provided for detecting intake air temperature T_ans is particularly advantageously attached in the upper area of internal combustion engine 1, because in this case particularly good temperature equalization (FIG. 4) is ensured.

Overall, the plausibility check according to the present invention allows future legal requirements in regard to the monitoring of temperature sensor 19, for example, to be met without additional hardware outlay, such as further temperature sensors or additional signal inputs on control unit 15. Existing control units—even those already in the field—may be provided with the functionality of the plausibility check according to the present invention by the computer program according to the present invention through a simple replacement of the computer program which currently controls them or even only parts thereof, for example.

A further advantage of the method according to the present invention is that the recognition of an error or a suspected error is possible even before the internal combustion engine is started, if the physical release conditions for the diagnosis are fulfilled. A final error detection may occur even a few seconds after the internal combustion engine is started as a function of the method used for detecting block heater operation.

1-16. (canceled)

17. A method for operating an internal combustion engine, comprising:
ascertaining an engine temperature and an intake air temperature; and
performing at least one of a plausibility check of an engine temperature using an intake air temperature and a plausibility check of the intake air temperature is performed using the engine temperature.

18. The method as recited in claim 17, wherein the engine temperature is compared to the intake air temperature.

19. The method as recited in claim 18, wherein a comparison between the engine temperature and the intake air temperature is performed in a predefinable time interval, preferably after the internal combustion engine has been shut down.

20. The method as recited in claim 19, wherein a comparison between the engine temperature and the intake air temperature is performed after a temperature equalization between the engine temperature and the intake air temperature.

21. The method as recited in claim 17, further comprising:
recognizing an error if a temperature difference between the engine temperature and the intake air temperature deviates by more than a predefinable threshold value from a temperature difference between the engine temperature and the intake air temperature at the instant the internal combustion engine is shut down.

22. The method as recited in claim 17, further comprising:
recognizing an error if the intake air temperature is less by more than a predefinable threshold value than an intake air temperature at the instant the internal combustion engine is shut down, and if a temperature difference between the engine temperature and the intake air temperature is greater than a predefinable threshold value.

23. The method as recited in claim 17, wherein the plausibility check is only performed when an error has not already been established in connection with the engine temperature and/or the intake air temperature.

24. The method as recited in claim 17, wherein the plausibility check is only performed when the internal combustion engine has previously reached an operating temperature.

25. The method as recited in claim 17, wherein the plausibility check is performed as a function of a cooling behavior of the internal combustion engine.

26. The method as recited in claim 17, wherein the plausibility check is performed as a function of an ambient temperature and/or a change in the ambient temperature.

27. The method as recited in claim 26, wherein the plausibility check is not performed if the change in the ambient temperature during a shutdown time of the internal combustion engine is greater than a predefinable threshold value.

28. A control unit for an internal combustion engine, comprising:
an arrangement for ascertaining an engine temperature and an intake air temperature; and
an arrangement for performing at least one of a plausibility check of an engine temperature using an intake air temperature and a plausibility check of the intake air temperature is performed using the engine temperature.

29. A computer program for a control unit of an internal combustion engine, the computer program when executed performing:
ascertaining an engine temperature and an intake air temperature; and
performing at least one of a plausibility check of an engine temperature using an intake air temperature and a plausibility check of the intake air temperature is performed using the engine temperature.

30. The computer program as recited in claim 29, wherein the computer program is stored on an electrical memory medium corresponding to a flash memory or a read-only memory.

28. An internal combustion engine for an internal combustion engine, comprising:
an arrangement for ascertaining an engine temperature and an intake air temperature; and
an arrangement for performing at least one of a plausibility check of an engine temperature using an intake air temperature and a plausibility check of the intake air temperature is performed using the engine temperature.
